(19) United States
(12) Patent Application Publication
(10) Pub. No.: US 2019/0292976 A1
(43) Pub. Date: Sep. 26, 2019

(54) CONTROL VALVE

(71) Applicant: YAMADA MANUFACTURING CO., LTD., Kiryu-shi (JP)

(72) Inventors: Akifumi Ozeki, Kiryu-shi (JP); Toshihito Nagai, Kiryu-shi (JP)

(21) Appl. No.: 16/290,187

(22) Filed: Mar. 1, 2019

(30) Foreign Application Priority Data
Mar. 26, 2018 (JP) 2018-058728

(51) Int. Cl. F01P 7/14; F01M 5/00; F01P 3/02; F01P 11/08; F01P 11/16; F02M 26/28

(52) U.S. Cl. CPC F01P 7/14; F01M 5/002; F01P 3/02; F01P 11/08; F01P 2060/04; F02M 26/28; F01P 2007/146; F01P 2025/08; F01P 11/16

(57) ABSTRACT

A rotor is configured to be movable among a heater water flow mode in which an air-conditioning outflow port communicates with the inside of a casing through an air-conditioning communication port, a heater cut mode in which communication between the air-conditioning outflow port and the inside of the casing through the air-conditioning communication port is cut off, and a switching mode in which a communicating area with the air-conditioning communication port in the air-conditioning outflow port varies in the process that the rotor shifts between the heater water flow mode and the heater cut mode, and the radiator outflow port communicates with the inside of the casing through the radiator communication port in the switching mode.

### CROSS-REFERENCE TO RELATED APPLICATION

Priority is claimed on Japanese Patent Application No. 2018-058728, filed Mar. 26, 2018, the content of which is incorporated herein by reference.

### BACKGROUND

### Field of the Invention

The present invention relates to a control valve.

### Description of Related Art

From the related art, a cooling system which cools an engine using cooling water is known. In this type of cooling system, separately from a radiator flow path circulating between a radiator and an engine, in some cases, a plurality of heat exchange flow paths for circulating the cooling water with various heat exchangers are provided.

In such a cooling system, a control valve for controlling circulation of the cooling water to each flow path is provided at a branching portion to each flow path (a radiator flow path, a heat exchange flow path, and the like). As a method of controlling the control valve to distribute the cooling water to each flow path, for example, a method disclosed in Japanese Unexamined Patent Application, First Publication No. 2016-156340 (hereinafter referred to as Patent Document 1) is known.

### SUMMARY

However, in the conventional technique described in Patent Document 1 described above, when switching from a heater cut mode to a heater water flow mode, in a case where the water temperature of the cooling water exceeds a prescribed value, in order to suppress boiling of the cooling water, it is necessary to wait until the water temperature of the cooling water becomes lower than the prescribed value before switching the mode. Therefore, in the conventional technique described in Patent Document 1, it takes time to switch from the heater cut mode to the heater water flow mode. The heater cut mode is a mode in which the cooling water is not allowed to flow through an air-conditioning flow path provided with an air-conditioning heater (a mode that does not allow water to pass through the heater). The heater water flow mode is a mode in which the cooling water is allowed to flow through the air-conditioning flow path and pass through the heater.

Therefore, according to the related art described in the above-mentioned Patent Document 1, even if a user performs an operation of requesting heating when the water temperature exceeds the prescribed value, it takes time until the heater actually starts heating.

An aspect of the present invention has been made in consideration of such circumstances, and an object thereof is to provide a control valve capable of shortening the time required for switching between a heater cut mode and a heater water flow mode.

In order to solve the above problem, the present invention adopts the following aspects.

(1) According to an aspect of the present invention, there is provided a control valve including: a casing having at least an inflow port into which a fluid flows, a first outflow port through which the fluid flows out to a heater core of an air conditioner, and a second outflow port through which the fluid flows out to a first heat exchanger configured to cool the fluid; and a valve which is movably accommodated in the casing and switches between communication and cutoff of an inside and an outside of the casing through the first outflow port and the second outflow port. The valve is provided with a first communication port communicable with the first outflow port and a second communication port communicable with the second outflow port. The valve is configured to be movable among a first position at which the first outflow port and the inside of the casing communicate with each other through the first communication port, a second position at which communication between the first outflow port and the inside of the casing through the first communication port is cut off, and a third position at which a communicating area with the first communication port in the first outflow port varies in a process in which the valve shifts between the first position and the second position. The second outflow port communicates with the inside of the casing through the second communication port at the third position.

According to the above aspect (1), since the second outflow port and the inside of the casing communicate with each other through the second communication port at the third position, when shifting between the first position and the second position, it is possible to allow the fluid to flow through the first heat exchanger. Thus, when the temperature of the fluid is higher than a prescribed value, it is possible to suppress the fluid from reaching an excessively high temperature (for example, boiling) and to quickly perform switching between the first position and the second position. Thus, it is possible to shorten the time required for switching between the first position and the second position.

(2) In the above aspect (1), the casing may be formed in a cylindrical shape, the valve may be formed in a cylindrical shape disposed coaxially with the casing and may be configured to be rotatable around an axis extending in an axial direction of the casing, the valve may pass through the third position when rotating in one side of a rotational direction in the process of shifting from the first position to the second position, and the valve may pass through a fourth position at which the communicating area with the first communication port in the first outflow port varies when rotating to the other side in the rotational direction, and communication between the second outflow port and the inside of the casing through the second communication port may be cut off at the fourth position.

According to the aspect (2), it is possible to prevent the fluid from flowing through the first heat exchanger by allowing the fluid to pass through the fourth position when shifting between the first position and the second position. Thus, when the temperature of the fluid is equal to or lower than the prescribed value, it is possible to avoid a drop in the temperature of the fluid. Therefore, for example, when the cooling water of the engine is used as the fluid, it is easy to maintain the high water temperature control of the engine, and it is possible to suppress a reduction in fuel economy of the engine.

In the aspect (2), the third position and the fourth position can be selected by switching the normal and reverse rotation of the valve at the time of shifting between the first position and the second position. As a result, it is possible to perform switching between the first position and the second position by allowing the fluid to pass through only one of the third position and the fourth position.

(3) In the above aspect (1) or (2), a third outflow port through which a fluid flows out to the second heat exchanger may be formed in the casing, a third communication port communicable with the third outflow port may be formed in the valve, and the third outflow port may communicate with the inside of the casing through the third communication port at the third position.

According to the above aspect (3), in addition to the first outflow port, the third outflow port communicates with the inside of the casing at the third position. Therefore, the temperature of the fluid can be lowered by allowing the fluid to flow through the second heat exchanger at the third position. Thus, it is possible to shorten the time required for switching between the first position and the second position.

(4) In any one of the above aspects (1) to (3), the second outflow port and the second communication port may be in a fully opened state at the third position. According to the above aspect (4), it is possible to allow more of the fluid to flow through the first heat exchanger at the third position. As a result, the temperature of the fluid can be quickly lowered.

According to aspects of the present invention, it is possible to shorten the time required for switching between the heater cut mode and the heater water flow mode.

### BRIEF DESCRIPTION OF THE DRAWINGS

FIG. 1 is a block diagram of a cooling system according to an embodiment.

FIG. 2 is a perspective view of a control valve according to the embodiment.

FIG. 3 is an exploded perspective view of the control valve according to the embodiment.

FIG. 4 is a cross-sectional view taken along the line IV-IV of FIG. 2.

FIG. 5 is a developed view of a valve cylinder section according to the embodiment.

FIG. 6 is a block diagram of a control device according to the embodiment.

FIG. 7 is a view illustrating an example of an opening degree schedule of the control valve according to the embodiment.

FIG. 8 is a flowchart illustrating an example of a control method of the control valve according to the embodiment.

### DETAILED DESCRIPTION OF THE INVENTION

Next, an embodiment of the present invention will be described on the basis of the drawings. In the following description, a case where a control valve of the present embodiment is adopted in a cooling system configured to cool an engine using cooling water will be described.

### [Cooling System]

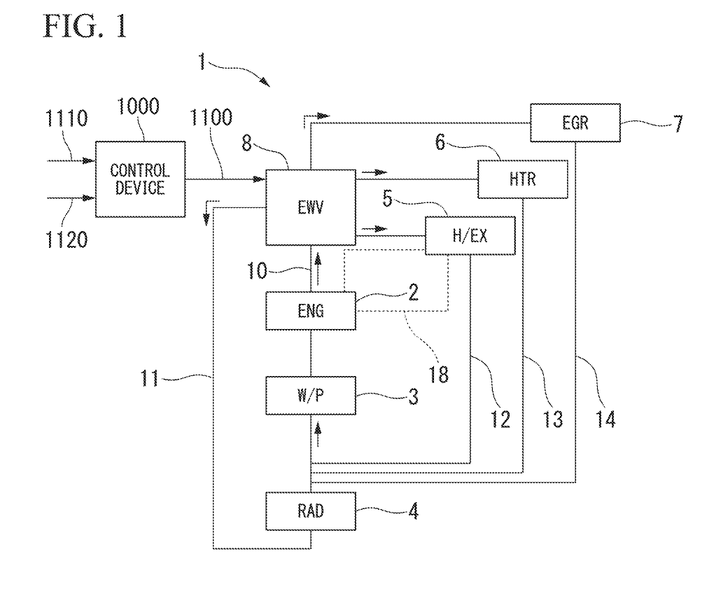

FIG. 1 is a block diagram of a cooling system 1.

As illustrated in FIG. 1, a cooling system 1 is mounted on a vehicle having at least an engine as a vehicle driving source. Instead of a vehicle having only an engine, the vehicle may be a hybrid vehicle, a plug-in hybrid vehicle or the like.

The cooling system 1 is configured so that an engine 2 (ENG), a water pump 3 (W/P), a radiator 4 (RAD), a heat exchanger 5 (H/EX), a heater core 6 (HTR), an EGR cooler 7 (EGR) and a control valve 8 (EWV) are connected by various flow paths 10 to 14.

The water pump 3, the engine 2 and the control valve 8 are connected in order from an upstream end to a downstream end on the main flow path 10. In the main flow path 10, the cooling water passes in order through the engine 2 and the control valve 8 by the operation of the water pump 3.

A radiator flow path 11, a warming-up flow path 12, an air-conditioning flow path 13, and an EGR flow path 14 are connected to the main flow path 10. The radiator flow path 11, the warming-up flow path 12, the air-conditioning flow path 13, and the EGR flow path 14 connect the upstream portion of the water pump 3 in the main flow path 10 and the control valve 8.

A radiator (a first heat exchanger) 4 is connected to the radiator flow path 11. In the radiator flow path 11, heat exchange between the cooling water and the outside air is performed in the radiator 4.

A heat exchanger (a second heat exchanger) 5 is connected to the warming-up flow path 12. Engine oil circulates between the heat exchanger 5 and the engine 2 through an oil flow path 18. In the warming-up flow path 12, heat exchange between the cooling water and the engine oil is performed in the heat exchanger 5. That is, the heat exchanger 5 functions as an oil warmer when the water temperature is higher than the oil temperature, and heats the engine oil. On the other hand, the heat exchanger 5 functions as an oil cooler when the water temperature is lower than the oil temperature, and cools the engine oil.

A heater core 6 is connected to the air-conditioning flow path 13. The heater core 6 is provided, for example, inside a duct (not illustrated) of the air conditioner. In the air-conditioning flow path 13, heat exchange between the cooling water and the air-conditioning air circulating in the duct is performed in the heater core 6.

An EGR cooler 7 is connected to the EGR flow path 14. In the EGR flow path 14, heat exchange between the cooling water and the EGR gas is performed in the EGR cooler 7.

In the cooling system 1 described above, after the cooling water having passed through the engine 2 in the main flow path 10 flows into the control valve 8, the cooling water is selectively distributed to the various flow paths 11 to 13 by the operation of the control valve 8. As a result, an early temperature rise or a high water temperature (optimal temperature) control can be attained, and improvement in fuel economy of the vehicle can be devised. The operation of the control valve 8 will be described below in detail.

### <Control Valve>

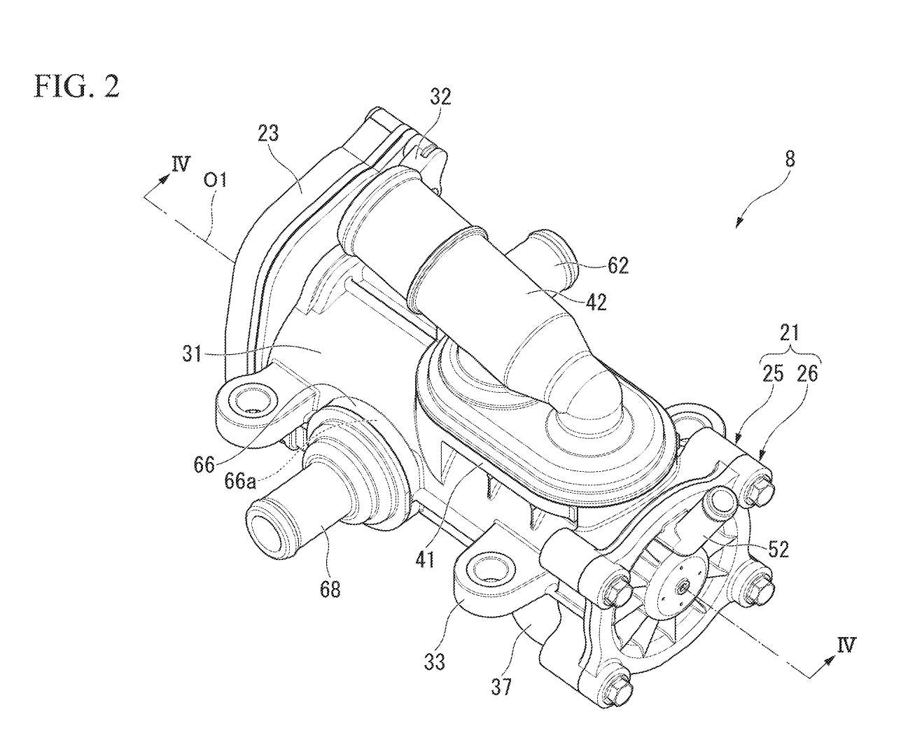

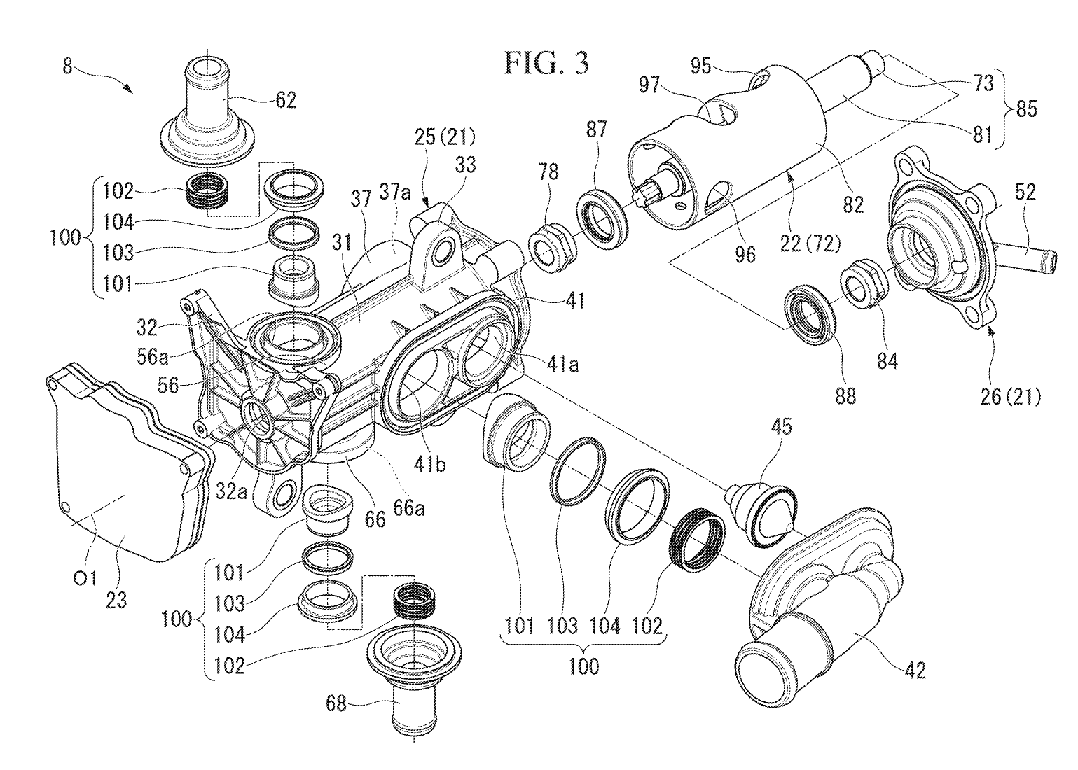

FIG. 2 is a perspective view of the control valve 8. FIG. 3 is an exploded perspective view of the control valve 8.

As illustrated in FIGS. 2 and 3, the control valve 8 includes a casing 21, a rotor 22 (see FIG. 3), and a drive unit 23.

### (Casing)

The casing 21 has a bottomed tubular casing main body 25 and a lid body 26 that closes an opening portion of the casing main body 25. In the following description, a direction along an axis O1 of the casing 21 is simply referred to as a case axial direction. A direction toward a bottom wall section 32 of the casing main body 25 with respect to a circumferential wall section 31 of the casing main body 25 in the case axial direction is referred to as a first side, and a direction toward the lid body 26 with respect to the circumferential wall section 31 of the casing main body 25 is referred to as a second side. Furthermore, a direction orthogonal to the axis O1 is referred to as a case radial direction, and a direction around the axis O1 is referred to as a case circumferential direction.

A plurality of mounting pieces 33 are formed on the circumferential wall section 31 of the casing main body 25. Each mounting piece 33 is provided to protrude outward from the circumferential wall section 31 in a case radial direction. The control valve 8 is fixed in an engine compartment via, for example, each mounting piece 33. The positions, the number, etc. of the mounting pieces 33 can be appropriately changed.

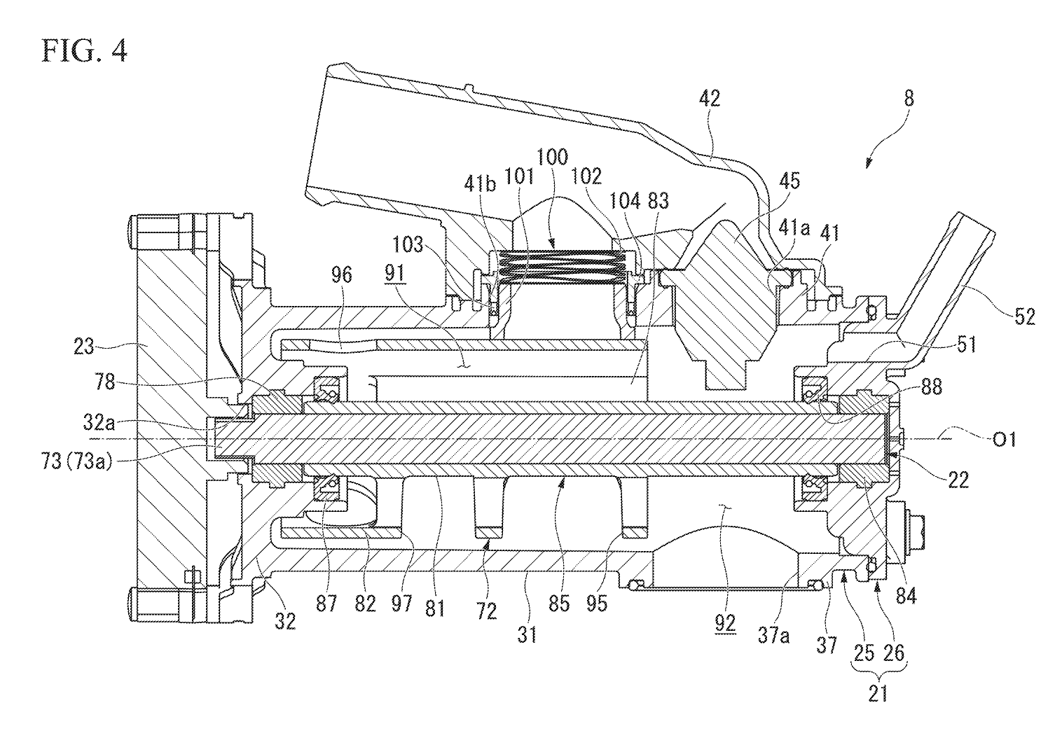

FIG. 4 is a cross-sectional view taken along line IV-IV of FIG. 2.

As illustrated in FIGS. 3 and 4, an inflow port 37 bulging outward in a case radial direction is formed in a portion located on the second side of the circumferential wall section 31. An inflow port 37a (see FIG. 4) penetrating the inflow port 37 in a case radial direction is formed in the inflow port 37. The inside and outside of the casing 21 communicate with each other through the inflow port 37a. The above-described main flow path 10 (see FIG. 1) is connected to an opening end surface (an outer end surface in a case radial direction) of the inflow port 37.

As illustrated in FIG. 4, a radiator port 41 bulging outward in a case radial direction is formed at a position of the circumferential wall section 31 opposite the inflow port 37 in the case radial direction with the axis O1 therebetween. In the radiator port 41, a fail opening 41a and a radiator outflow port (a second outflow port) 41b are formed side by side in the case axial direction. The fail opening 41a and the radiator outflow port 41b both penetrate the radiator port 41 in a case radial direction. In the present embodiment, the fail opening 41a faces the above-described inflow port 37a in the case radial direction. The radiator outflow port 41b is located on the first side of the fail opening 41a in the case axial direction.

A radiator joint 42 is connected to the opening end surface (the outer end surface in the case radial direction) of the radiator port 41. The radiator joint 42 connects the radiator port 41 and the upstream end portion of the radiator flow path 11 (see FIG. 1). The radiator joint 42 is welded (for example, vibration welded or the like) to the opening end surface of the radiator port 41.

A thermostat 45 is provided in the fail opening 41a. That is, the thermostat 45 is opposite the aforementioned inflow port 37a in the case radial direction. The thermostat 45 opens and closes the fail opening 41a depending on the temperature of the cooling water flowing in the casing 21.

The radiator port 41 may have at least the radiator outflow port 41b.

An EGR outflow port 51 is formed in a portion of the lid body 26 located closer to the radiator port 41 in the case radial direction with respect to the axis O1. The EGR outflow port 51 passes through the lid body 26 in a case axial direction.

In the lid body 26, an EGR joint 52 is formed on the opening edge of the EGR outflow port 51. The EGR joint 52 connects the EGR outflow port 51 and the upstream end portion of the EGR flow path 14 (see FIG. 1). In the present embodiment, the EGR joint 52 is integrally formed with the lid body 26. However, the EGR joint 52 may be formed separately from the lid body 26. The EGR outflow port 51 and the EGR joint 52 may be provided in the circumferential wall section 31 or the like.

As illustrated in FIG. 3, a warming-up port 56 bulging outward in a case radial direction is formed in a portion of the circumferential wall section 31 located closer to the first side in the case axial direction than the radiator port 41. A warming-up outflow port (a third outflow port) 56a which penetrates the warming-up port 56 in a case radial direction is formed in the warming-up port 56. A warming-up joint 62 is connected to an opening end surface of the warming-up port 56. The warming-up joint 62 connects the warming-up port 56 and the upstream end portion of the above-described warming-up flow path 12 (see FIG. 1). The warming-up joint 62 is welded (for example, vibration welded or the like) to the open end surface of the warming-up port 56.

As illustrated in FIG. 2, an air-conditioning port 66 is formed between the radiator port 41 and the warming-up port 56 in the case axial direction, and at a position of the circumferential wall section 31 shifted from the warming-up port 56 by approximately 180° in the case circumferential direction. An air-conditioning outflow port (a first outflow port) 66a which penetrates the air-conditioning port 66 in a case radial direction is formed in the air-conditioning port 66. An air-conditioning joint 68 is connected to the opening end surface of the air-conditioning port 66. The air-conditioning joint 68 connects the air-conditioning port 66 and the upstream end portion of the air-conditioning flow path 13 (see FIG. 1).

The air-conditioning joint 68 is welded (for example, vibration welded or the like) to the open end surface of the air-conditioning port 66.

### (Drive Unit)

As illustrated in FIG. 2, the drive unit 23 is mounted on the bottom wall section 32 of the casing main body 25. The drive unit 23 is configured to accommodate a motor, a speed reduction mechanism, a control board and the like which are not illustrated. The motor installed on the drive unit 23 can detect a rotation amount by a rotation sensor such as a Hall IC or the like.

### (Rotor)

As illustrated in FIGS. 3 and 4, the rotor (valve) 22 is accommodated in the casing 21.

The rotor 22 is formed in a cylindrical shape disposed coaxially with the axis O1 of the casing 21.

The rotor 22 rotates about the axis O1 to open and close the above-described respective outflow ports (the radiator outflow port 41b, the warming-up outflow port 56a, and the air-conditioning outflow port 66a).

As illustrated in FIG. 4, the rotor 22 is formed by insert-molding an inner shaft section 73 inside the rotor main body 72.

The inner shaft section 73 is formed of a material (for example, a metal material) having rigidity higher than that of the rotor main body 72 (for example, a resin material). The inner shaft section 73 extends coaxially with the axis O1.

The rotor 22 may be integrally formed of, for example, a resin material or the like.

The first side end portion of the inner shaft section 73 penetrates the bottom wall section 32 through a penetration port 32a formed in the bottom wall section 32 in the case axial direction. A first side end portion of the inner shaft section 73 is rotatably supported by a first bush 78 provided on the above-described bottom wall section 32. A first lip seal 87 is provided in a portion of the bottom wall section 32 located on the second side in the case axial direction with respect to the first bush 78.

A connecting section 73a is formed in a portion of the inner shaft section 73 located closer to the first side in the case axial direction than the first bush 78 (a portion located outside the bottom wall section 32). The connecting section 73a is formed to have a smaller diameter than a portion of the inner shaft section 73 other than the connecting section 73a, and a spline is formed on an outer circumferential surface thereof. The connecting section 73a is connected to the above-described drive unit 23 outside the casing 21. As a result, the power of the drive unit 23 is transmitted to the inner shaft section 73.

The second side end portion of the inner shaft section 73 is rotatably supported by a second bush 84 provided on the above-mentioned lib body 26. A second lip seal 88 is provided in a portion of the lid body 26 located on the first side in the case axial direction with respect to the second bush 84.

The rotor main body 72 surrounds the periphery of the above-described inner shaft section 73. The rotor main body 72 has an outer shaft section 81 that covers the inner shaft section 73, a valve cylinder section 82 that surrounds the outer shaft section 81, and a spoke portion 83 that connects the outer shaft section 81 and the valve cylinder section 82.

The outer shaft section 81 surrounds the entire periphery of the inner shaft section 73 in a state in which both end portions of the inner shaft section 73 in the case axial direction are exposed. In this embodiment, the outer shaft section 81 and the inner shaft section 73 constitute a rotary shaft 85 of the rotor 22.

The valve cylinder section 82 is disposed coaxially with the axis O1. The valve cylinder section 82 is disposed in a portion of the casing 21 located closer to the first side in the case axial direction than the inflow port 37a. Specifically, the valve cylinder section 82 is disposed at a position that avoids the fail opening 41a in the case axial direction, and straddles the radiator outflow port 41b, the warming-up outflow port 56a, and the air-conditioning outflow port 66a. The inside of the valve cylinder section 82 constitutes a circulation path 91 through which the cooling water flowing into the casing 21 through the inflow port 37a circulates in the case axial direction. On the other hand, a portion in the casing 21 located closer to the second side in the case axial direction than the valve cylinder section 82 constitutes a connection flow path 92 that communicates with the circulation path 91.

In the valve cylinder section 82, at the same position as the above-described radiator outflow port 41b in the case axial direction, a radiator communication port (a second communication port) 95 penetrating the valve cylinder section 82 in a case radial direction is formed. When the radiator communication port 95 at least partly overlaps the radiator outflow port 41b when viewed from the case radial direction, the radiator outflow port 41b and the inside of the circulation path 91 are made to communicate with each other through the radiator communication port 95.

In the valve cylinder section 82, at the same position as the warming-up outflow port 56a in the case axial direction, a warming-up communication port (a third communication port) 96 which penetrates the valve cylinder section 82 in a case radial direction is formed. When the warming-up communication port 96 at least partly overlaps the warming-up outflow port 56a when viewed from the case radial direction, the warming-up outflow port 56a and the inside of the circulation path 91 are made to communicate with each other through the warming-up communication port 96.

In the valve cylinder section 82, at the same position as the aforementioned air-conditioning outflow port 66a in the case axial direction, an air-conditioning communication port (a first communication port) 97 which penetrates the valve cylinder section 82 in a case radial direction is formed. When the air-conditioning communication port 97 at least partly overlaps the air-conditioning outflow port 66a when viewed from the case radial direction, the air-conditioning outflow port 66a and the inside of the circulation path 91 are made to communicate with each other through the air-conditioning communication port 97.

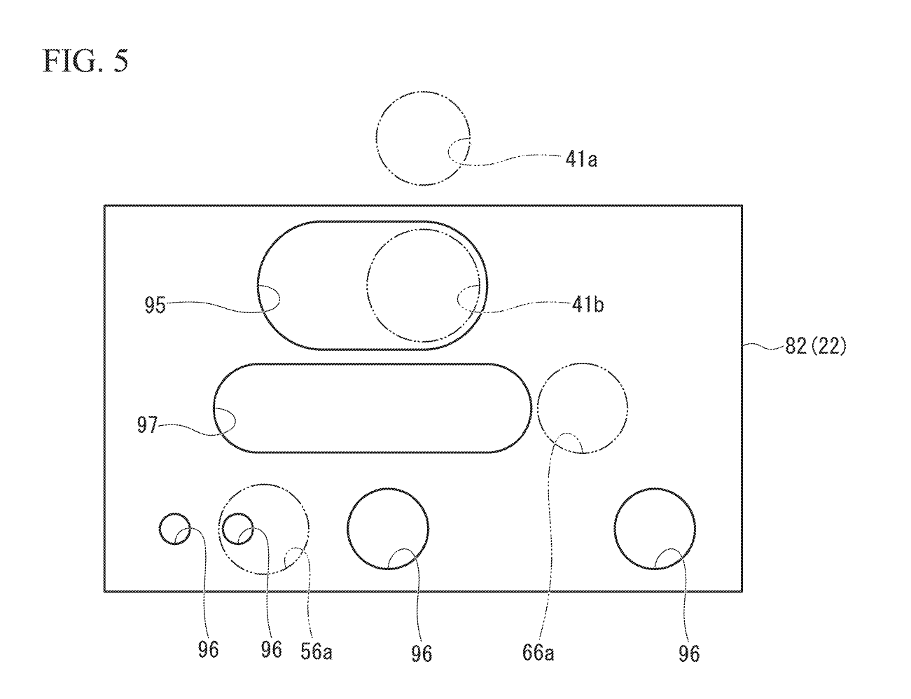

FIG. 5 is a developed view of the valve cylinder section 82.

As illustrated in FIG. 5, the radiator communication port 95 has an elliptical shape in which the case circumferential direction is set as a long axis direction.

The warming-up communication port 96 is formed, for example, as a round port. A plurality of warming-up communication ports 96 are formed at intervals in the case circumferential direction. In the illustrated example, the warming-up communication port 96 has two large-diameter ports aligned in the case circumferential direction, and two small-diameter ports smaller than the large-diameter ports in the case circumferential direction.

The air-conditioning communication port 97 is formed in an elliptical shape in which the case circumferential direction is set as the long axis direction.

As illustrated in FIG. 3, a seal mechanism 100 is provided in the above-described radiator port 41 (the radiator outflow port 41b). The seal mechanism 100 has a sliding ring 101, a biasing member 102, a seal ring 103, and a holder 104.

As illustrated in FIG. 4, the sliding ring 101 is inserted into the radiator outflow port 41b. In a case radial direction, the inner end surface of the sliding ring 101 is slidably in contact with the outer circumferential surface of the valve cylinder section 82. In the present embodiment, the inner end surface of the sliding ring 101 is a curved surface formed to follow the radius of curvature of the valve cylinder section 82.

The seal ring 103 is externally fitted to the sliding ring 101. The outer circumferential surface of the seal ring 103 is slidably in close contact with the inner circumferential surface of the radiator outflow port 41b.

The biasing member 102 is interposed between the outer end surface of the sliding ring 101 in the case radial direction and the radiator joint 42. The biasing member 102 biases the sliding ring 101 toward the inner side in the case radial direction (toward the valve cylinder section 82).

The holder 104 is disposed outside the seal ring 103 in the case radial direction, and between the outer circumferential surface of the seal ring 103 and the inner circumferential surface of the radiator outflow port 41b. The holder 104 restricts the outward movement of the seal ring 103 in the case radial direction.

As illustrated in FIG. 3, a seal mechanism 100 having the same structure as the seal mechanism 100 provided in the radiator outflow port 41b is also provided in the warming-up outflow port 56a and the air-conditioning outflow port 66a. In the present embodiment, the seal mechanism 100 provided in the warming-up outflow port 56a and the air-conditioning outflow port 66a is denoted by the same reference numeral as the seal mechanism 100 provided in the radiator outflow port 41b, and the explanation thereof is omitted.

### <Control Device>

As illustrated in FIG. 1, the cooling system 1 of the present embodiment controls the operation of the control valve 8 (the rotor 22) by the control device 1000, thereby switching communication and cutoff between the inside of the circulation path 91 and each of the outflow ports 41b, 56a and 66a. In the following description, when there is no need to distinguish the outflow ports 41b, 56a and 66a and the communication ports 95 to 97, in some cases, they may be simply referred to as an outflow port or a communication port without giving reference numerals.

A control signal 1100 is input from the control device 1000 to the control valve 8. The control signal 1100 is a signal for controlling the operation of the control valve 8. The control valve 8 changes the opening degrees (a communicating area with the communication port in the outflow port) of each outflow port in accordance with the control signal 1100 that is input from the control device 1000. The opening degree of the outflow port represents a degree of opening with respect to an upper limit (a maximum opening area) of the opening area of the outflow port. The opening degree of the outflow port may be represented by a ratio (percentage) of the opening area when a maximum opening area is taken as 100%.

The cooling water temperature signal 1110 indicating the water temperature of the cooling water is input to the control device 1000. The water temperature of the cooling water is measured by a water temperature sensor (not illustrated) provided on the main flow path 10 and at a place in which the cooling water has passed through the engine 2. The cooling water temperature signal 1110 indicates the water temperature of the cooling water measured by the water temperature sensor.

An engine operating status signal 1120 indicating the engine operating status of the engine 2 is input to the control device 1000. The engine operating status signal 1120 includes a signal indicating the rotational speed of the engine 2, a signal indicating the load of the engine 2, a signal indicating a throttle opening degree of the engine 2, a signal indicating the intake air temperature of the engine 2, and the like.

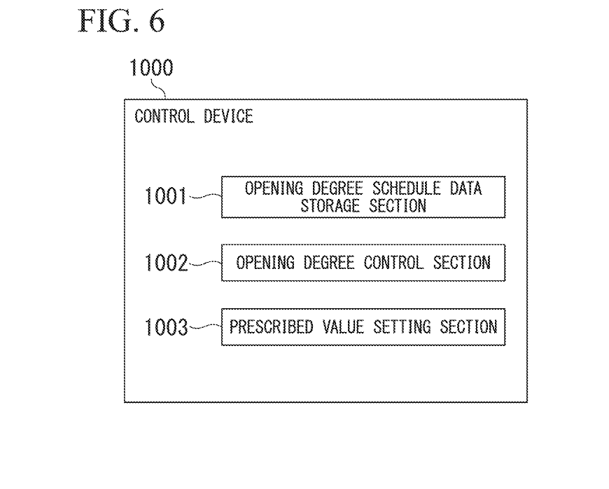

FIG. 6 is a block diagram of the control device 1000.

The control device 1000 illustrated in FIG. 6 includes an opening degree schedule data storage section 1001, an opening degree control section 1002, and a prescribed value setting section 1003.

The opening degree schedule data storage section 1001 stores the opening degree schedule data indicating an opening degree schedule. The opening degree schedule is a schedule of the opening degrees of the radiator outflow port 41b, the warming-up outflow port 56a and the air-conditioning outflow port 66a of the control valve 8. The opening degree schedule includes at least a heater cut mode, a heater water flow mode, a fully closed mode, and a switching mode, as modes in which the opening degrees of the radiator outflow port 41b, the warming-up outflow port 56a and the air-conditioning outflow port 66a of the control valve 8 are defined.

The heater cut mode is a mode in which the radiator outflow port 41b is opened in the status in which the air-conditioning outflow port 66a is closed. The heater water flow mode is a mode in which the radiator outflow port 41b is opened in the status in which the air-conditioning outflow port 66a is opened. The fully closed mode is a mode in which all of the warming-up outflow port 56a, the radiator outflow port 41b, and the air-conditioning outflow port 66a are closed. The switching mode is a mode in which the opening and closing of the air-conditioning outflow port 66a are switched in a status in which the radiator outflow port 41b and the warming-up outflow port 56a are opened.

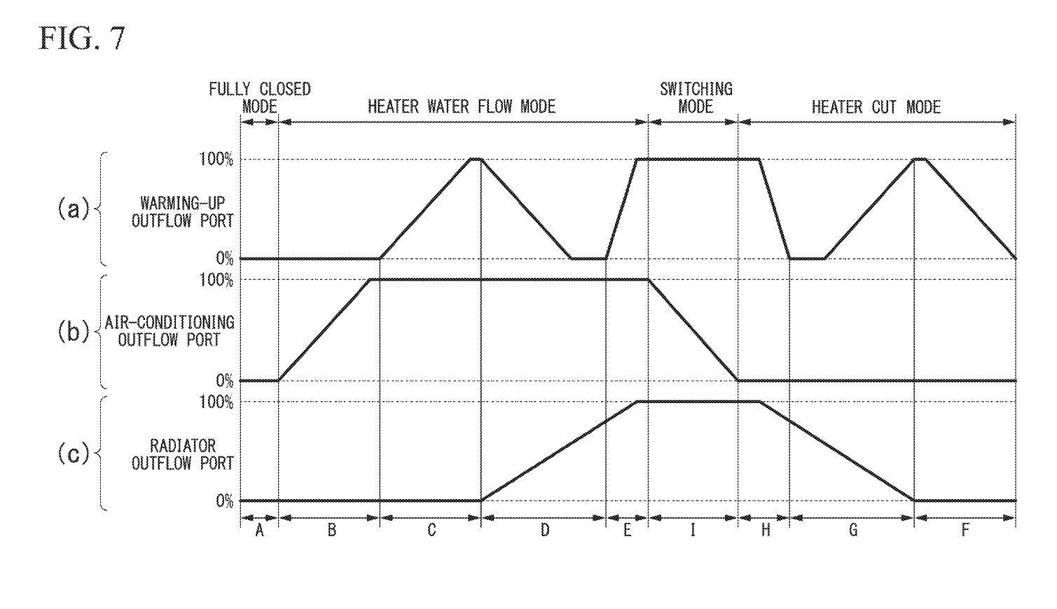

An example of the opening degree schedule will be described with reference to FIG. 7. FIG. 7 is a diagram illustrating an example of the opening degree schedule.

A horizontal axis of FIG. 7 illustrates an operating range of the control valve 8. The vertical axis in FIG. 7 illustrates the opening degree (0% to 100%) of each outflow port. FIG. 7(a) illustrates the opening degree of the warming-up outflow port 56a. FIG. 7(b) illustrates the opening degree of the air-conditioning outflow port 66a. FIG. 7(c) illustrates the opening degree of the radiator outflow port 41b.

The operating range of the control valve 8 is divided into nine regions A, B, C, D, E, F, H and I. Between adjacent regions in FIG. 7, regions can be shifted to each other. The rotor 22 of the present embodiment is configured to be rotatable 360° in both directions of a normal rotational direction and a reverse rotational direction by detecting the rotation amount of the motor by the rotation sensor.

The fully closed mode is made up of only a region A. In the region A, all the opening degrees of the warming-up outflow port 56a, the air-conditioning outflow port 66a, and the radiator outflow port 41b become 0%.

The heater water flow mode is made up of four regions B, C, D and E. In the region B, the opening degrees of the warming-up outflow port 56a and the radiator outflow port 41b remains 0%, and the opening degree of the air-conditioning outflow port 66a varies within a range from 0% to 100%. In the region C, the opening degree of the radiator outflow port 41b remains 0%, the opening degree of the air-conditioning outflow port 66a is 100%, and the opening degree of the warming-up outflow port 56a varies in the range from 0% to 100%. In the region D, the opening degree of the air-conditioning outflow port 66a remains 100%, the opening degree of the warming-up outflow port 56a varies within a range from 100% to 0%, and the opening degree of the radiator outflow port 41b varies in the range from 0% to about 80%. In the region E, the opening degree of the air-conditioning outflow port 66a remains 100%, the opening degree of the warming-up outflow port 56a varies in the range from 0% to 100%, and the opening degree of the radiator outflow port 41b varies in the range from about 80% to 100%.

The switching mode is made up of only the region I. In the region I, the opening degrees of the warming-up outflow port 56a and the radiator outflow port 41b remain 100%, and the opening degree of the air-conditioning outflow port 66a varies within a range from 100% to 0%.

The heater cut mode includes three regions H, G and F. In the region H, the opening degree of the air-conditioning outflow port 66a remains 0%, the opening degree of the warming-up outflow port 56a varies within a range from 100% to 0%, and the opening degree of the radiator outflow port 41b varies in the range from 100% to about 80%. In the region the opening degree of the air-conditioning outflow port 66a remains 0%, the opening degree of the warming-up outflow port 56a varies in the range from 0% to 100%, and the opening degree of the radiator outflow port 41b varies in the range from about 80% to 0%. In the region F, the opening degrees of the air-conditioning outflow port 66a and the radiator outflow port 41b remain 0%, and the opening degree of the warming-up outflow port 56a varies in the range from 100% to 0%.

The explanation is returned to FIG. 6.

The opening degree control section 1002 uses the opening degree schedule indicated by the opening degree schedule data stored in the opening degree schedule data storage section 1001 to control the opening degrees of the radiator outflow port 41b, the warming-up outflow port 56a, and the air-conditioning outflow port 66a. The opening degree control section 1002 generates a control signal 1100 for instructing the opening degrees of the radiator outflow port 41b, the warming-up outflow port 56a, and the air-conditioning outflow port 66a of the control valve 8. The opening degrees of the radiator outflow port 41b, the warming-up outflow port 56a, and the air-conditioning outflow port 66a of the control valve 8 are controlled by inputting the control signal 1100 from the control device 1000 to the control valve 8.

The opening degree control section 1002 determines whether to perform switching between the heater cut mode (a second position) and the heater water flow mode (a first position) via the fully closed mode (a fourth position) or the switching mode (a third position), on the basis of the prescribed value of the water temperature of the cooling water (the cooling water temperature) and the cooling water temperature indicated by the cooling water temperature signal 1110.

The prescribed value setting section 1003 sets a prescribed value of the cooling water temperature. The prescribed value of the cooling water temperature may be arbitrarily set or may be fixedly set. As an example of the present embodiment, the prescribed value setting section 1003 holds a plurality of candidate values as candidates for the prescribed value of the cooling water temperature. Three candidate values of, for example, 85° C., 90° C. and 95° C. are used as candidate values of the prescribed value of the cooling water temperature. For each candidate value, the engine operating status to which the candidate values are applied is determined. The prescribed value setting section 1003 holds data indicating the engine operating status to which each candidate value is applied. The prescribed value setting section 1003 holds a candidate value corresponding to the engine operating status indicated by the engine operating status signal 1120 as the setting value of the prescribed value of the cooling water temperature. The prescribed value setting section 1003 changes the candidate value to be set to the prescribed value of the cooling water temperature, depending on the change in the engine operating status indicated by the engine operating status signal 1120.

The control device 1000 may be achieved by dedicated hardware or is configured by an ECU (Engine Control Unit), a memory and the like and may achieve the function by executing the computer program for achieving the functions of the respective parts of FIG. 6 through the ECU.

Thus, as illustrated in FIGS. 5 and 7, in the control valve 8 of the present embodiment, positions of the outflow ports and the communication ports corresponding to the respective outflow ports are set to satisfy the aforementioned opening degree schedule. In this case, each communication port of the valve cylinder section 82 is set so that the radiator outflow port 41b and the circulation path 91 communicate with each other, the warming-up outflow port 56a and the circulation path 91 communicate with each other, and the air-conditioning outflow port 66a and the circulation path 91 communicate with each other, for example, in the switching mode of the region I. In particular, in the present embodiment, in the switching mode, the opening degree of the air-conditioning outflow port 66a changes due to the rotation of the rotor 22. The radiator outflow port 41b overlaps the entire radiator communication port 95, and the warming-up outflow port 56a overlaps the warming-up communication port 96 (opening degree is 100%).

However, among the radiator outflow port 41b and the warming-up outflow port 56a, at least the radiator outflow port 41b may communicate with the circulation path 91 in the switching mode. The radiator outflow port 41b and the warming-up outflow port 56a do not need to be in the fully open state in the switching mode, and at least a part thereof may communicate with the circulation path 91.

In the control valve 8 of the present embodiment, each communication port of the valve cylinder section 82 is set so that communication between all the outflow ports of the radiator outflow port 41b, the warming-up outflow port 56a and the air-conditioning outflow port 66a and the circulation path 91 is cut off in the fully closed mode of the region A.

### [Operating Method of Control Valve]

Next, a method of operating the aforementioned control valve 8 will be described.

As illustrated in FIG. 1, in the main flow path 10, the cooling water delivered by the water pump 3 is heat-exchanged in the engine 2 and then circulates toward the control valve 8. As illustrated in FIG. 4, the cooling water having passed through the engine 2 in the main flow path 10 flows into the connection flow path 92 in the casing 21 through the inflow port 37a.

Among the cooling water flowing into the connection flow path 92, some of the cooling water flows into the EGR outflow port 51. The cooling water flowing into the EGR outflow port 51 is supplied into the EGR flow path 14 through the EGR joint 52. The cooling water supplied into the EGR flow path 14 is returned to the main flow path 10 after heat exchange between the cooling water and the EGR gas is performed in the EGR cooler 7.

On the other hand, among the cooling water flowing into the connection flow path 92, the cooling water that did not flow into the EGR outflow port 51 flows into the circulation path 91 from the second side in the case axial direction. The cooling water flowing into the circulation path 91 is distributed to the respective outflow ports in the course of flowing through the circulation path 91 in the case axial direction. That is, the cooling water flowing into the circulation path 91 is distributed to each of the flow paths 11 to 13 through the outflow port communicating with the communication port among the outflow ports.

In the control valve 8, in order to switch the opening degree schedule between the outflow port and the communication port, the rotor 22 is rotated around the axis O1. Thus, the communication and the cutoff between the outflow port and the communication port are switched depending on the rotational position of the rotor 22.

### [Control Method of Control Valve]

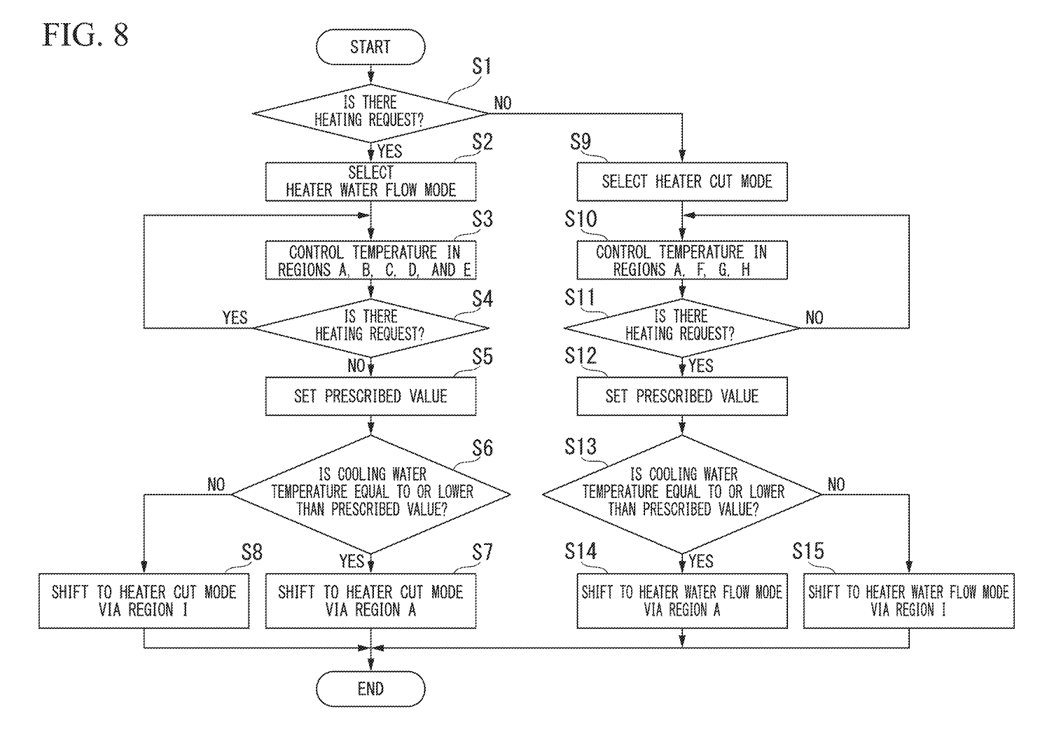

A method of controlling the control valve 8 will be described with reference to FIG. 8. FIG. 8 is a flowchart illustrating an example of a control method of the control valve 8. Here, the method of controlling the control valve 8 will be described with the opening degree schedule illustrated in FIG. 7 as an example of the opening degree schedule.

(Step S1) The control device 1000 determines the presence or absence of a heating request. A signal indicating the presence or absence of the heating request is input to the control device 1000 from an operation unit (not illustrated) of the vehicle on which the cooling system 1 is mounted. When there is a heating request, the process proceeds to step S2, and if not, the process proceeds to step S9.

(Step S2) The opening degree control section 1002 selects the heater water flow mode.

(Step S3) The opening degree control section 1002 performs a control of changing the opening degrees of the radiator outflow port 41b, the warming-up outflow port 56a and the air-conditioning outflow port 66a of the control valve 8 within the range of the five regions A, B, C, D, and E of the opening degree schedule illustrated in FIG. 7 to control the cooling water temperature within a predetermined range. In the example of FIG. 8, when the heater water flow mode is selected, the heater water flow mode and the fully closed mode are used.

(Step S4) The control device 1000 determines the presence or absence of the heating request. When there is a heating request, the process returns to step S3, and if not, the process proceeds to step S5.

(Step S5) The prescribed value setting section 1003 sets a prescribed value of the cooling water temperature corresponding to the engine operating status indicated by the engine operating status signal 1120.

(Step S6) The opening degree control section 1002 compares the prescribed value of the cooling water temperature with the cooling water temperature indicated by the cooling water temperature signal 1110. As a result of the comparison, when the cooling water temperature indicated by the cooling water temperature signal 1110 equal to or lower than the prescribed value, the process proceeds to step S7, and if not, the process proceeds to step S8.

(Step S7) The opening degree control section 1002 performs shifting from the region B of the heater water flow mode to the region F of the heater cut mode via the region A of the fully closed mode. In the case of passing through the region A, since the rotor 22 rotates, for example, in the normal rotational direction, the radiator communication port 95 does not pass through the radiator outflow port 41b, the warming-up communication port 96 does not pass through the warming-up outflow port 56a, and the communication between the air-conditioning outflow port 66a and the air-conditioning communication port 97 is cut off. Therefore, the warming-up outflow port 56a, the radiator outflow port 41b, and the air-conditioning outflow port 66a are all temporarily closed, during shifting from the heater water flow mode to the heater cut mode. In this way, when the cooling water temperature indicated by the cooling water temperature signal 1110 is equal to or lower than the prescribed value, by preventing the cooling water from flowing through the radiator 4, it is possible to obtain an effect of avoiding the temperature drop of the cooling water to suppress a decrease in the fuel economy of the engine 2.

(Step S8) The opening degree control section 1002 shifts from the region E of the heater water flow mode to the region H of the heater cut mode via the region I of the switching mode. When passing through the region I, for example, since the rotor 22 rotates, for example, in the reverse rotational direction, in a status in which the radiator outflow port 41b communicates with the circulation path 91 through the radiator communication port 95, and the warming-up outflow port 56a communicates with the circulation path 91 through the warming-up communication port 96, the communication between the air-conditioning outflow port 66a and the air-conditioning communication port 97 is cut off. Therefore, during the shifting from the heater water flow mode to the heater cut mode, the opening degree of the warming-up outflow port 56a and the radiator outflow port 41b remains 100%, and the opening degree of the air-conditioning outflow port 66a is changed from 100% to 0%. In this way, when the cooling water temperature indicated by the cooling water temperature signal 1110 exceeds the prescribed value, it is possible to perform shifting from the heater water flow mode to the heater cut mode by causing the cooling water to pass through the radiator 4, while suppressing the boiling of the cooling water.

(Step S9) The opening degree control section 1002 selects the heater cut mode.

(Step S10) The opening degree control section 1002 performs a control of changing the opening degrees of the radiator outflow port 41b, the warming-up air outflow port 56a and the air-conditioning outflow port 66a of the control valve 8 within the range of the four regions A, F, G and H of the opening degree schedule illustrated in FIG. 7 to keep the cooling water temperature within a predetermined range.

In the example of FIG. 8, when the heater cut mode is selected, the heater cut mode and the fully closed mode are used.

(Step S11) The control device 1000 determines the presence or absence of the heating request. If there is a heating request, the process proceeds to step S12, and if not, the process returns to step S10.

(Step S12) The prescribed value setting section 1003 sets a prescribed value of the cooling water temperature corresponding to the engine operating status indicated by the engine operating status signal 1120.

(Step S13) The opening degree control section 1002 compares the prescribed value of the cooling water temperature with the cooling water temperature indicated by the cooling water temperature signal 1110. As a result of this comparison, if the cooling water temperature indicated by the cooling water temperature signal 1110 is equal to or lower than the prescribed value, the process proceeds to step S14, and if not, the process proceeds to step S15.

(Step S14) The opening degree control section 1002 shifts from the region F of the heater cut mode to the region B of the heater water flow mode via the region A of the fully closed mode. Therefore, the warming-up outflow port 56a, the radiator outflow port 41b, and the air-conditioning outflow port 66a are all temporarily closed during the shifting from the heater cut mode to the heater water flow mode. In this way, when the cooling water temperature indicated by the cooling water temperature signal 1110 is equal to or lower than the prescribed value, by preventing the cooling water from flowing through the radiator 4, it is possible to obtain an effect of avoiding the temperature drop of the cooling water to prevent a decrease in the fuel consumption of the engine 2.

(Step S15) The opening degree control section 1002 performs shifting from the region H of the heater cut mode to the region E of the heater water flow mode via the region I of the switching mode. Accordingly, during the shifting from the heater cut mode to the heater water flow mode, the opening degrees of the warming-up outflow port 56a and the radiator outflow port 41b remain 100%, and the opening degree of the air-conditioning outflow port 66a is changed from 0% to 100%. In this way, when the cooling water temperature indicated by the cooling water temperature signal 1110 exceeds the prescribed value, by causing the cooling water to pass through the radiator 4, it is possible to quickly shift from the heater cut mode to the heater water flow mode, while preventing the boiling of the cooling water. As a result, even if the user performs an operation of requesting heating when the cooling water temperature exceeds the prescribed value, heating can be quickly started by the heater core, which can contribute to improvement in convenience for the user.

In this way, the present embodiment has a configuration in which each of the communication ports 95 and 97 of the valve cylinder section 82 are set such that the radiator outflow port 41b communicates with the circulation path 91, and the air-conditioning outflow port 66a communicate with the circulation path 91 in the switching mode.

According to this configuration, when shifting between the heater water flow mode and the heater cut mode, it is possible to allow the cooling water to flow through the radiator 4. Thus, when the cooling water temperature is higher than the prescribed value, it is possible to quickly perform switching between the heater water flow mode and the heater cut mode, while suppressing the boiling of the cooling water. Thus, it is possible to shorten the time required for switching between the heater cut mode and the heater water flow mode.

In the present embodiment, each of the communication ports 95 to 97 of the valve cylinder section 82 are set so that the communication between all the outflow ports of the radiator outflow port 41b, the warming-up outflow port 56a, and the air-conditioning outflow port 66a and the circulation path 91 is cut off in the fully closed mode.

According to this configuration, when shifting between the heater water flow mode and the heater cut mode, it is possible to prevent the cooling water from flowing through the radiator 4. Accordingly, when the cooling water temperature is equal to or lower than the prescribed value, since the temperature decrease of the cooling water can be avoided, it is easy to maintain the high water temperature control of the engine 2, and the reduction of the fuel consumption of the engine 2 can be suppressed.

In addition, in the present embodiment, the fully closed mode and the switching mode can be selected by switching the normal and reverse rotation of the rotor 22 at the time of shifting between the heater water flow mode and the heater cut mode. As a result, it is possible to switch between the heater water flow mode and the heater cut mode by allowing the cooling water to pass through only one of the fully closed mode and the switching mode.

In the present embodiment, the communicating ports 96 and 97 of the valve cylinder section 82 are set such that the warming-up outflow port 56a communicates with the circulation path 91, and the air-conditioning outflow port 66a communicates with the circulation path 91 in the switching mode.

According to this configuration, in addition to the radiator outflow port 41b, the warming-up outflow port 56a communicates with the circulation path 91. Therefore, in the switching mode, by utilizing the heat exchanger 5 as an oil warmer, it is possible to lower the temperature of the cooling water. Thus, it is possible to shorten the time required for switching between the heater cut mode and the heater water flow mode.

In the present embodiment, the radiator outflow port 41b and the warming-up outflow port 56a are configured to be a fully open state in the switching mode.

According to this configuration, it is possible to allow more cooling water to flow through the radiator 4 and the heat exchanger 5. As a result, the temperature of the cooling water can be rapidly lowered.

Although preferred embodiments of the present invention have been described above, the present invention is not limited to these examples. Additions, omissions, substitutions, and other changes in the configuration can be made within the scope that does not depart from the spirit of the present invention. The invention is not limited by the foregoing description, but only by the scope of the appended claims.

For example, in the above-described embodiment, the configuration in which the control valve 8 is mounted on the cooling system 1 of the engine 2 has been described, but the present invention is not limited to this configuration, and which the control valve 8 may be mounted in other systems.

In the above-described embodiment, the configuration in which the cooling water flowing into the control valve 8 is distributed to the radiator flow path 11, the warming-up flow path 12, the air-conditioning flow path 13, and the EGR flow path 14 has been described. However, the invention is not limited thereto. The control valve 8 may have any configuration as long as it distributes the cooling water flowing into the control valve 8 to at least the radiator flow path 11 and the warming-up flow path 12.

In the above-described embodiment, the case in which the radiator outflow port 41b and the air-conditioning outflow port 66a are formed as elongated ports has been described, but the invention is not limited to this configuration. That is, if the radiator outflow port 41b communicates with the circulation path 91 and the air-conditioning outflow port 66a communicates with the circulation path 91 in the switching mode, the shape, layout, and the like of each outflow port can be appropriately changed.

In the above described embodiment, for example, the configuration in which the inflow port, each communication port, and each outflow port penetrate the valve cylinder section 82 and the casing 21 in the case radial direction have been described, but the present invention is not limited to this configuration. For example, each communication port and each outflow port may penetrate the valve cylinder section 82 and the casing 21 in the case axial direction, respectively.

In the above-described embodiment, the configuration in which the valve (the rotor 22) according to the present invention rotates around the axis O1 has been described, but the present invention is not limited to this configuration. For example, the valve may be configured to move in the case axial direction.

In the above-described embodiment, the case in which the rotor 22 (the valve cylinder section 82) and the casing 21 (the circumferential wall section 31) are each formed in a cylindrical shape (a uniform diameter over the entire case axial direction) has been described, but the present invention is not limited to the configuration. In other words, as long as the valve cylinder section 82 is configured to be rotatable in the circumferential wall section 31, the outer diameter of the valve cylinder section 82 and the inner diameter of the circumferential wall section 31 may be changed in the case axial direction.

In this case, for example, the valve cylinder section 82 and the circumferential wall section 31 can adopt various shapes, such as a spherical shape (a shape in which a diameter decreases from a central portion in the case axial direction toward both end portions), a saddle shape (a shape in which a diameter increases from the central portion in the case axial direction toward both end portions), a shape having a tertiary curved surface such as a shape in which a plurality of spherical or saddle shapes are consecutive in the case axial direction, a tapered shape (a shape in which a diameter gradually changes from the first side to the second side in the case axial direction), and a stepped shape (shape in which a diameter gradually changes from the first side to the second side in the case axial direction).

In the above embodiment, the rotor 22 according to the present invention has been described by exemplifying the valve cylinder section 82 having the openings on both sides in the axial direction, but the present invention is not limited to this configuration. As long as the rotor 22 is rotatable in the casing 21 and a valve port is formed to allow communication between the inside and the outside, the rotor 22 may be a hollow rotating body in which at least one of the case axial direction is cut off. In this case, it is possible to adopt a spherical shape, a hemispherical shape or the like for the hollow rotating body.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A control valve comprising:
a casing having at least an inflow port into which a fluid flows, a first outflow port through which the fluid flows out to a heater core of an air conditioner, and a second outflow port through which the fluid flows out to a first heat exchanger configured to cool the fluid; and
a valve which is movably accommodated in the casing and switches between communication and cutoff of an inside and an outside of the casing through the first outflow port and the second outflow port,
wherein the valve is provided with a first communication port communicable with the first outflow port and a second communication port communicable with the second outflow port,
the valve is configured to be movable among a first position at which the first outflow port and the inside of the casing communicate with each other through the first communication port,
a second position at which communication between the first outflow port and the inside of the casing through the first communication port is cut off, and
a third position at which a communicating area with the first communication port in the first outflow port varies in a process in which the valve shifts between the first position and the second position, and
the second outflow port communicates with the inside of the casing through the second communication port at the third position.

2. The control valve according to claim 1, wherein the casing is formed in a cylindrical shape,
the valve is formed in a cylindrical shape disposed coaxially with the casing and is configured to be rotatable around an axis extending in an axial direction of the casing,
the valve passes through the third position when rotating in one side of a rotational direction in the process of shifting from the first position to the second position, and passes through a fourth position at which the communicating area with the first communication port in the first outflow port varies when rotating to the other side in the rotational direction, and
communication between the second outflow port and the inside of the casing through the second communication port is cut off at the fourth position.

3. The control valve according to claim 1, wherein a third outflow port through which a fluid flows out to the second heat exchanger is formed in the casing,
a third communication port communicable with the third outflow port is formed in the valve, and
the third outflow port communicates with the inside of the casing through the third communication port at the third position.

4. The control valve according to claim 1, wherein the second outflow port and the second communication port are in a fully opened state at the third position.
